(19) United States
(12) Patent Application Publication
(10) Pub. No.: US 2007/0276523 A1
(43) Pub. Date: Nov. 29, 2007

(54) Central cradling device with integrated detachable wireless component

(76) Inventor: Kenneth A. Alley, Tampa, FL (US)

Correspondence Address: LAW OFFICES OF MARK A. GARZIA, P.C., 2058 CHICHESTER AVE, BOOTHWYN, PA, 19061, US

(21) Appl. No.: 11/683,414

(22) Filed: Mar. 7, 2007

Related U.S. Application Data
(60) Provisional application No. 60/779,674, filed on Mar. 7, 2006.

(51) Int. Cl. G06F 17/00

(52) U.S. Cl. 700/94

(57) ABSTRACT

A communication system having a primary communication device and a wireless headset. The primary communication device could be a cellular telephone and has an integrated electro-mechanical interface for sharing certain circuits common to both the cell phone and the headset, e.g., a battery charging system, an LCD for conveying status information, etc.

### CROSS REFERENCE TO RELATED APPLICATIONS

The present application claims the benefits under all relevant U.S. statutes, including the benefit of priority under 35 U.S.C. §119(e), to U.S. Provisional Application No. 60/779,674 filed Mar. 7, 2006, titled HEADSET/EARPHONES WITH AUTO-MUTE SAFETY DEVICE FOR AUDIO DEVICES AND CELLULAR PHONE in the name of Kenneth A. Alley.

U.S. Provisional Application No. 60/779,674, filed Mar. 7, 2006, is hereby incorporated by reference as if fully set forth herein.

### FIELD OF THE INVENTION

This invention relates generally to a wireless communication device and, more particularly to a wireless headset that integrates into a base unit such as cellular phone or PDA.

### BRIEF DESCRIPTION OF THE PRIOR ART

Both cellular telephones and wireless headsets are commonplace today. The most recent models of cellular phones include wireless capabilities, that allows communication between a cellular telephone and a wireless headset, such as Bluetooth™. Utilizing Bluetooth and/or similar wireless technologies thus, provides the means to operate a handset or cellular phone in a hands-free mode. This is a highly desirable feature, since many states prohibit the use of a cellular phone while driving a vehicle without the use of the hands-free headset.

Due to the fact that there are numerous manufacturers of cellular phones and even more manufacturers of wireless headsets, there are limited standards regarding their power supply charging systems. Therefore, every time you purchase a new cellular phone or wireless headset, it is common that you need to purchase a new charging system for each of the units. Moreover, each device usually includes a charging system for use in the home or wall outlet and one for use in the automobile via a cigarette lighter interface. There are known charging products that provide attachments to allow a single device to charge several models, although most charge only a manufacturer's brand of phone (e.g., only Nokia but not Motorola or Samsung). In the case of cellular phones, it would be highly desirable if both the phone and the wireless headset could be charged simultaneously (during regular charging schedules) with a single charger for both the cell phone and the wireless headset.

Additionally, most of the headsets that are manufactured today are designed to work with numerous cellular phone models and therefore require design capabilities that allow flexibility thus, increasing the cost of the headsets. If headsets could be designed to adhere to only one or two standards, manufacturing costs would be lowered.

Once the headset is synchronized to a particular cellular phone the two units must work together in order to function. Although they have wireless capabilities and provide short distance operation between one another, the user still needs both the cellular telephone and wireless headset to operate the system.

Additionally, both the wireless headset and the cellular telephone needs their respective batteries charged in order to operate. This requires two separate chargers that are independent of one another and often include different rate dissipation of their respective power supplies.

The wireless headset is virtually worthless without the cellular phone. Therefore, it would make sense that the two units either had a carrying case that incorporated both the cellular phone and wireless headset and/or a cellular phone with a built-in, removable integrated wireless headset. The present disclosure describes such a device.

### SUMMARY OF THE INVENTION

The present invention is a wireless headset that is integrated into a base unit (e.g., a cellular telephone) such that certain electrical circuits may be shared between the two units. The cellular telephone is the primary electronic device and is sometimes referred to as the “mother device.” The removable and integrated wireless headset is not only designed to communicate with the mother device but is also designed to share certain internal circuitry of the mother device. For example; when the mother device's battery is being charged by a standard external charging mechanism, the removable headset will simultaneously be charged. Additionally, the mother device will provide feedback as to the status of the removable wireless headset's battery and or other desired information.

The present invention is ore than just a cradling or other docking mechanism in the mother device. The removable wireless headset is preferably designed to communicate with and to ergonomically fit within the physical geometry of the mother device. There are numerous designs of mother devices accepting, receiving or accommodating a removable wireless headsets that could be incorporated into an integrated system. The most desired of these designs would include a removable wireless headset with a small profile that snaps either onto the outside of the mother device, and/or partially inserts into the main body of the mother device with easy access to remove it when needed. When the removable wireless headset is inserted into the mother device it becomes fully integrated with the mother device's internal circuitry. A mother device would convey to a user (e.g., via a LCD screen), data regarding the operating status and/or power supply of both the mother device and the removable section (headset).

The present invention also provides means to transport the two units together and provides convenient charging and managing of the compatible components. The present invention includes a mother device that may share components with removable sections of the mother device, thus, providing a mother device which can be built by interchanging components/segments, similar to that of a personal computer.

### BRIEF DESCRIPTION OF THE DRAWINGS

The foregoing summary, as well as the following detailed description may be better understood when read in conjunction with the accompanying drawings, which are incorporated in and form a part of the specification. The drawings serve to explain the principles of the invention and illustrate embodiments of the present invention that are preferred at the time the application was filed. It should be understood, however, that the invention is not limited to the precise arrangements and instrumentalities shown. In the drawings:

FIG. 1 represents a simplified schematic of the internal charging scheme of a cellular phone with an integrated and detachable-removable wireless headset.

FIG. 2 is a perspective front view of an audio device (such as an ipod) with an integrated and detachable-removable headset that is designed to communicate with the internal circuitry of the audio device such as: but not limited to, the battery charging and feedback circuitry of the audio device and/or its external charging mechanism. Additionally, the detachable wireless headset may include numerous geometric designs and shapes thus both, functional ergonomic shapes and non-functional geometric shapes (round, oval, rectangular, etc).

FIG. 3 is a perspective side view of a similar communication device to the one that is shown in FIG. 2, in this particular view the detachable wireless headset is in the detached position. Additionally, this view illustrates the ergonomic design of both the communication device and the detachable headset. For example: when the wireless headset is re-attached to the communication device, the wireless headset will form a smooth flush surface.

FIG. 4 is a perspective isometric view of the detached wireless headset shown in FIG. 3. In this particular example, the earpiece is similar to that of typical earplugs. There are several different designs that may be used to attach the headset to the ear or earlobe.

FIG. 5 is an isometric view of an alternative wireless headset. In this particular design the earplug is pivotal and/or snaps into the body of the wireless headset when not in use. The benefit of a flexible earplug or attachment means will provide a smaller profile, thus allowing the headset to be placed into or within a mother devices limited space. This particular wireless headset incorporates an elongated shape that maybe designed to slide into a receiving receptacle of a cellular phone, similar to the one shown in FIG. 6.

FIG. 6 is a perspective side view of a cellular phone/PDA that includes a receptacle on its top surface whereby the removable wireless headset slides into, thus communicating with the internal circuitry of the cellular phone.

FIG. 7 represents multiple views of an alternative designed removable-detachable wireless headset that incorporate flexible fingers that attach to the inner earlobe. The flexible fingers or attachment means are straight and aligned with the body of the headset when in the static position (FIG. 7A) and when the fingers are pushed outward (FIG. 7B) they form attachment means that will grip the earlobe. This is just one example of numerous designs that could be incorporated to adapt to a removable wireless headset. The more desires designs will include removable headsets that are small enough to fit within the limited confines of a mother device such as a cellular phone.

FIG. 8 is a front view of a new concept PDA/Cellular Phone/Audio Device. In this particular example the round-saucer shaped removable wireless headset may share the speaker and/or microphone with the mother device. When the wireless headset is removed from the mother device the speaker and microphone are also removed from the mother device. This particular configuration may also include a detachable LCD screen. The concept allows the interchangeability of individual components similar to that of building a personal computer.

FIG. 9 is an alternative concept of a carrying case designed to carry both a mother device and a typical wireless headset that does not attach to the mother devices internal circuitry. This carrying case would allow existing wireless headsets and cellular phones to be carried together in a single case.

### DETAILED DESCRIPTION OF THE PREFERRED EMBODIMENT

In describing a preferred embodiment of the invention, specific terminology will be selected for the sake of clarity. However, the invention is not intended to be limited to the specific terms so selected.

As one can appreciate after reading this disclosure, an integrated wireless communication system in accordance with the present invention may take many forms. One embodiment is where the primary or mother device is a cellular telephone and the secondary device is a wireless headset. Accordingly, this invention will be described using a cellular phone/wireless headset as the preferred embodiment, keeping in mind that the mother device may be an MP3 player, computer, PDS, cordless phone, or any of a myriad of other devices.

The present invention is a cellular phone or PDA with an integrated and removable wireless headset. The removable and integrated wireless headset of the cellular phone, from here on referred to as the mother device, is designed to communicate with the internal circuitry of the mother device. The mother device may include components that are attachable and removable from the mother device. The components may include a removable section that operates as a wireless headset. The integrated wireless headset may include shared components with the mother device such as; the microphone and speaker of the mother device could be detached and become part of the wireless headset components, etc. or the detachable wireless headset section could incorporate its own microphone and speaker.

When the wireless headset (section/component) is attached (via electromechanical interface) to the mother device and the mother devices battery is being charged by its standard external charging mechanism, the removable headset (section/component) may simultaneously be charged. Additionally, the mother device will provide feedback on its LCD on both, the mother device and the removable wireless headset (section/component) such as; the battery status of the removable wireless headset and/or other desired information. The removable wireless headset includes and interface that mechanically connects to the internal circuitry of the mother device when the headset is attached/integrated to the mother device.

The wireless headset interface can be designed to communicate with the mother devices external charging mechanism as well (with or without an adapter), this particular feature will provide the means to charge the wireless headset independently of the mother device utilizing the same charging mechanism, also lowering the cost and providing greater flexibility and function-ability of both devices.

The removable wireless headset is designed communicate with and to ergonomically fit within the physical geometry of the mother device. The removable wireless headset may be designed with flexible fingers to help attach itself to the inner earlobe during use. These flexible fingers may be designed to have a small profile when not in use thus, making it easy to fit within the confines of the mother devices profile. There are numerous designs that could be adapted to incorporate attachable and removable sections/components of a mother device with such integrated component technologies.

The communication device in accordance with the present invention has a primary/mother device with an integrated docking station for receiving an integrated detachable-removable wireless headset. The integrated wireless headset includes a physical/electro-mechanical interface that is designed to communicate with the internal circuitry of the cellular phone (communication device) and vice versa. The communication device includes a mating physical/electro-mechanical interface that physically and electrically connects the interface of the integrated wireless headset to the mother device.

The charging circuitry of the communication system 100 includes means to simultaneously charge the internal batteries of both the cellular phone and the integrated removable wireless headset when the integrated removable wireless headset is attached to and physically mated with the cellular phone. The charging circuitry of the communication system 100 may include means to prioritize, control and or program specific charging schemes of both units.

Some of the circuitry common to both a cellular phone and a wireless headset includes means to display the internal battery status of both the integrated removable wireless headset and the cellular phone; the display means may be a simple bar chart or an LCD.

The cellular phone according to the present invention includes means to ergonomically mate and integrate a detachable wireless headset to the cellular phone. The means to mate the integrated wireless headset may include snapping the detachable wireless headset to the outside of the cellular phone or partially inserting the detachable wireless headset within the body or interior of the cellular phone thus, encasing the integrated detachable wireless headset within the cellular phones interior.

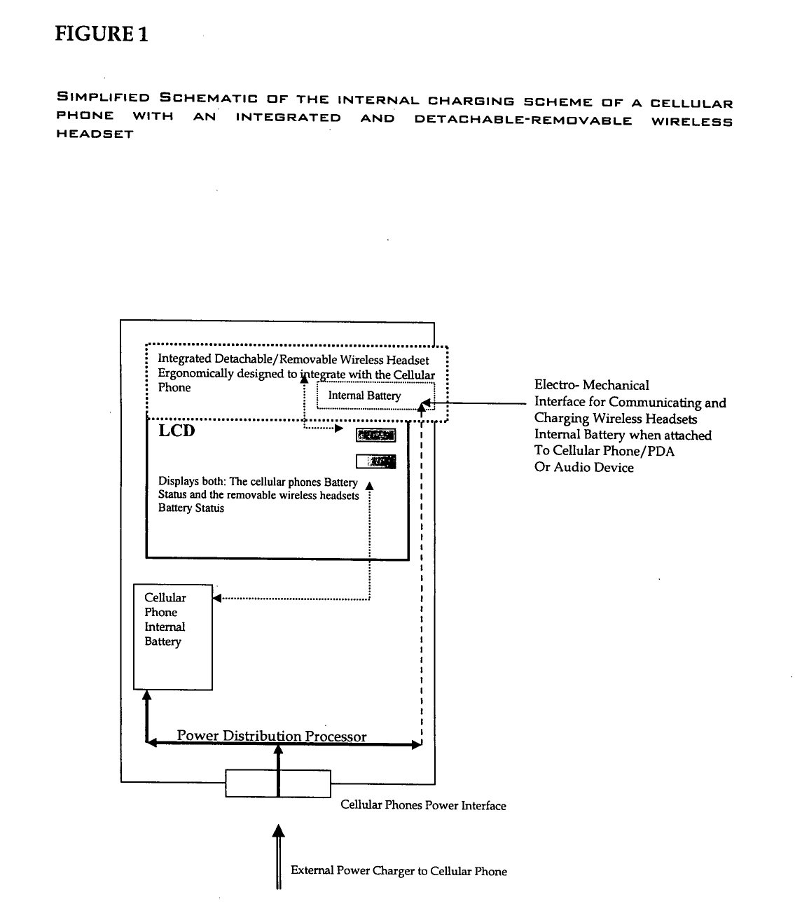

Referring now to FIG. 1, a simplified schematic of a communication system 100 in accordance with the present invention is illustrated. The invention will now be described in association with a cellular telephone 16 and a wireless headset 17. FIG. 1 shows how the headset 17 is intimately tied into the cellular phone 16 via an electro-mechanical interface.

The internal charging scheme of a cellular phone simultaneously charging the integrated and detachable/removable wireless headset can be seen in FIG. 1. When the cellular phone 16 is charged (by the cellular phone's external power charger) the cellular phone's internal battery 18 is charged along with the internal battery 19 of the integrated removable wireless headset 17.

The charging scheme may be designed to operate in several different modes; for example, both units (the cellular telephone 16 and the wireless headset 17) may be simultaneously charged or one may be prioritized over the other. This feature may be controlled by the mother device's power distribution processor or a controller. The subject cellular telephone may include a battery status indicator 31 similar to a typical cellular phone that is displayed on the LCD 30 there may also be a battery status indicator 32 for the removable/detachable integrated wireless headset. This may be accomplished by the internal circuitry of the cellular phone (as shown) and or by the wireless capabilities of both the cellular phone, and the integrated removable wireless headset.

The cellular phone 16 of FIG. 1 includes a physical/electro-mechanical interface for integral mating with the integrated removable wireless headset 17. More specifically, this electro-mechanical interface provides the means of communication between the cellular phone 16 when the removable integrated wireless headset 17 is docked to the cellular phone. The communication includes charging both the cellular phone, and the internal battery of the integrated removable wireless headset. Other data may be obtained from this communication as well such as the battery status of both of the units being displayed on the LCD of the cellular phone.

When the integrated wireless headset is removed from the cellular phone it will operate as any other wireless headset (e.g., using the Bluetooth communication protocol). The electro-mechanical interface means of the integrated removable wireless headset may also be designed to communicate with the cellular phones, external charging mechanism. This feature will allow both, the cellular phone and the integrated wireless headset to be charged independent of one another with and/or without a special attachment thus, utilizing the same external charger designed for the cellular phone. Additionally, the integrated wireless headset may be designed to share components with the mother device.

U.S. Pat. No. 7,130,584 titled METHOD AND DEVICE FOR IDENTIFYING AND PAIRING BLUETOOTH DEVICES to Petri M. Hirvonen, discloses some background information on how a Bluetooth device may operate. U.S. Pat. No. 7,130,584 is hereby incorporated by reference as if fully set forth herein.

Although FIG. 1 refers to a cellular phone, this same internal charging scheme could be utilized with PDA's, tablet computers, and/or audio devices, and numerous other communication devices that require or may benefit from an integrated detachable removable wireless headset.

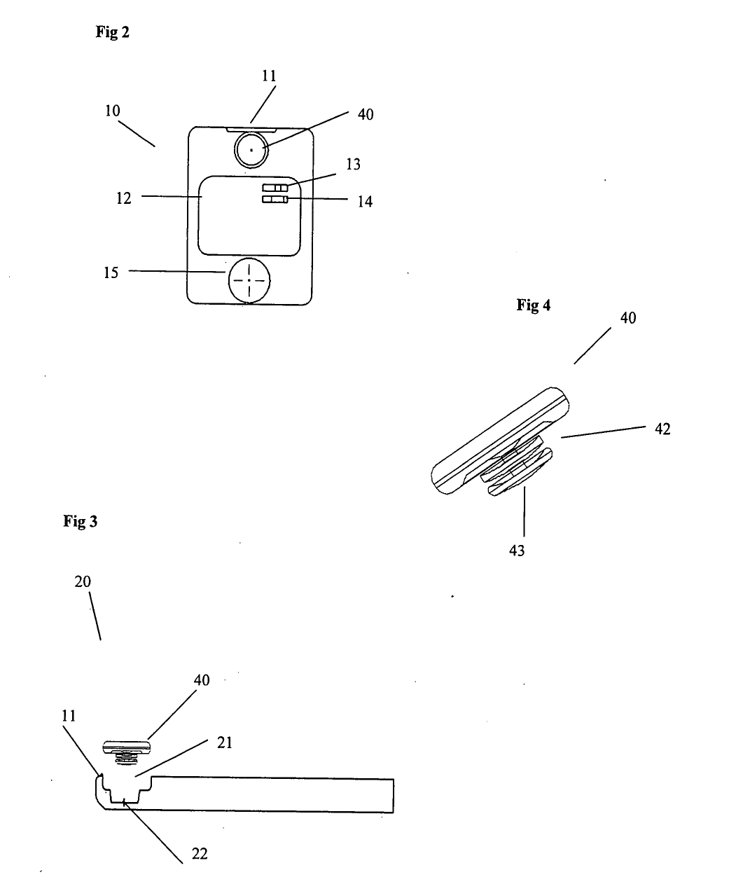

Referring now to FIG. 2, a perspective front view of audio device 10 (such as an iPod® or an MP3 player) with an integrated and detachable/removable headset 40 that is designed to communicate with the internal circuitry of the audio device such as, but not limited to, the battery charging and feedback circuitry of the audio device and/or its external charging mechanism. Additionally, the detachable wireless headset may include numerous geometric designs and shapes thus both, functional ergonomic shapes and non-functional geometric shapes (round, oval, rectangular, etc).

Audio device 10 includes LCD 12 and battery status icons 13 and 14. Battery status icon, 13 provides status of the audio device and battery status icon 14 provides the status of the internal battery of removable headset 40. As described in FIG. 1, when audio device 10 is charged both the internal battery of the audio device and the internal battery of the removable wireless headset 40 will be charged. The attachment mechanism 11 locks the removable wireless headset 40 in place when it is integrated with the audio device 10.

FIG. 3 illustrates a perspective side view of a similar communication device to the one shown in FIG. 2 but includes a docking receptacle 21 for receiving the wireless handset 40. In this particular view the detachable wireless headset 40 is in the detached position. Additionally, this view illustrates the ergonomic design of both the communication device 20 and the detachable headset 40. For example, when the wireless headset is re-attached (snapped into receptacle 21) to the communication device, the wireless headset will form a smooth flush surface. The removable wireless headset 40 includes interface means 24 that communicate with the interface means 22 of audio device 20.

As illustrated, the docking receptacle 21 has a specific contour and the wireless headset 40 has a mating contour that allows for a one-piece profile when the headset 40 is docked in the mother device 20. The specific contour is designed to provide a secure electrical connection between the mother device 20 and the headset 40 when docked, and to physically secure the headset to the mother device until the user decides to remove the headset 40 from its docking receptacle 21.

Now referring to FIG. 4, a perspective isometric view of the detached wireless headset 40 shown in FIG. 3 is presented. In this particular example, the earpiece 42 is similar to that of a typical earplug. There are several different designs that may be used to attach the headset to the ear or earlobe. Wireless headset 40 includes mechanical interface 43 that communicates with the interface 22 of device 20. When headset 40 is detached, it may be operated as a standard wireless headset using RF communication. When the wireless headset is attached to the mother device there is a physical and/or a electro-mechanical link interface that provides the means for both the removable wireless headset to communicate with the mother device such as charging the internal batteries of both, the mother device and removable wireless headset.

Now referring to FIG. 5, an isometric view of wireless headset 50 is shown. In this particular design earplug 53 includes pivoting means 52 (or snapping means). When wireless headset 50 is not in use, earplug 53 will snap or rotate/pivot into the main body of wireless headset 50. Interface 55 will communicate with the interface 65 of the mother device.

The benefit of a flexible earplug (or attachment means), is that it will provide a smaller profile, thus allowing the headset to be placed into or within a mother device requiring less space. This particular wireless headset incorporates an elongated shape that maybe designed to slide into a receiving receptacle of a cellular phone, similar to the one shown in FIG. 6.

Referring now to FIG. 6, a side view of cellular phone/PDA 60, includes receptacle 63 on its top surface whereby the removable wireless headset 50 slides into, thus communicating with the internal circuitry of the cellular phone. More specifically, interface means 55 of the removable wireless headset 50 and interface means 65, of mother device 60 will provide the necessary communication means.

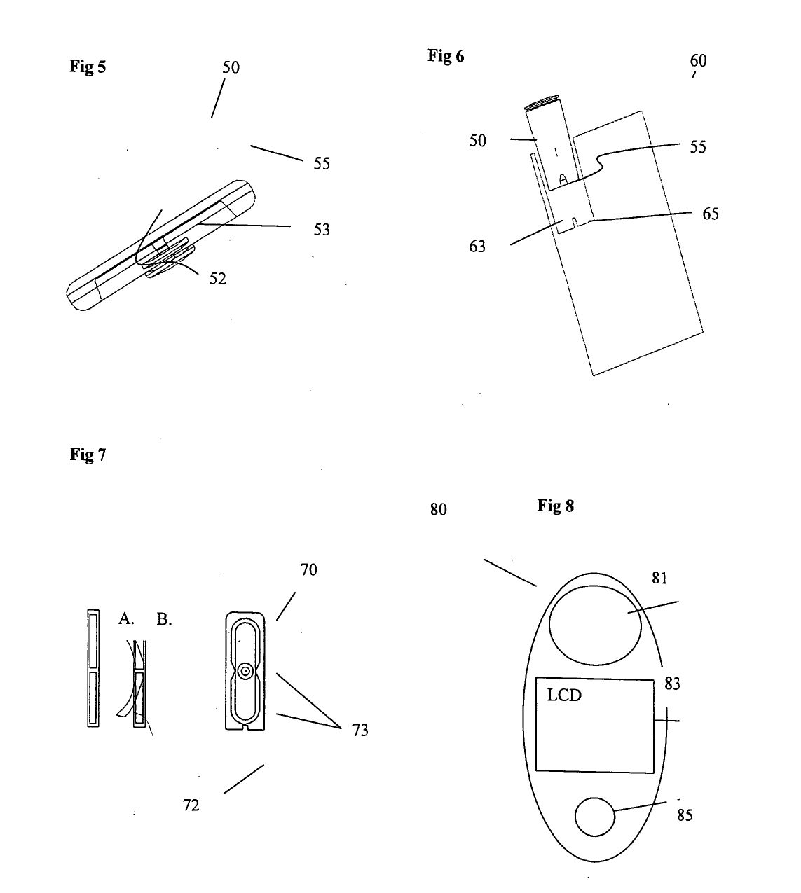

Referring now to FIGS. 7A and 7B, multiple views of an alternative embodiment of a removable-detachable wireless headset 70 that incorporates flexible fingers 73 that attach to the inner earlobe of the user. Removable/detachable wireless headset 70 includes interface means 72.

The flexible fingers or attachment means are straight and aligned with the body of the headset when in the static position (shown in FIG. 7A) and when the fingers are pushed outward (shown in FIG. 7B) they form attachment means that will grip the earlobe. This is just one example of numerous designs that could be incorporated to adapt to a removable wireless headset. The more desirable designs will include removable headsets that are small enough to fit within the limited confines of a mother device such as a cellular phone.

Referring now to FIG. 8, a front view of a new concept PDA/Cellular Phone/Audio Device in accordance with the present invention is shown. In this particular embodiment, the round/saucer-shaped, removable wireless headset 81 may share the speaker 81 and/or microphone 85 with the mother device 80. When the wireless headset is removed from the mother device the speaker and microphone are also removed from the mother device. This particular embodiment may also include a detachable LCD screen 83. The removable wireless headset 81 may also include a liquid crystal display (LCD) on its outer surface and an ear lobe attaching means (similar to the one previously shown) on its interior surface. Device 80 may also include controller circuit. This concept allows the interchangeability of individual components similar to that of building a personal computer.

FIG. 8 is meant to illustrate that any feature of the primary/mother device and a secondary device (such as a headset) can be incorporated into the secondary device. For example, if it is preferable to have a vibration mechanism to provide a tactile notification of an incoming call, it can be incorporated into the wireless headset. Therefore, when the headset is docked with the cellular phone (i.e., when the two components are being charged simultaneously), the vibration mechanism will be activated when an incoming call is sensed. Also, when the headset is not in the docking station (e.g., it is hanging on the ear of a user), the vibration mechanism in the headset will still be activated when an incoming call is sensed, and the user will be notified. By installing the vibration mechanism in the headset, manufacturing expenses will be reduced since two separate vibration mechanisms will not be required.

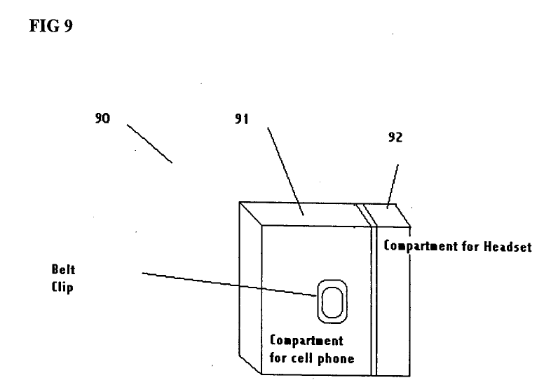

An alternative concept of a carrying case designed to carry both a mother device and a typical wireless headset that does not attach to the mother device's internal circuitry is illustrated in FIG. 9. This carrying case would allow existing wireless headsets and cellular phones to be carried together in a single case. Carrying case 90 includes sections and/or compartments 91 and 92. The mother device may be carried in section 91 and a standard wireless headset may be carried in section 92. Carrying case 90 may also include a belt clip, and all were detachable sections.

The present invention may also include a carrying case that incorporates multiple compartments to hold a communication device in one section and a typical wireless headset within another section. The typical wireless headset may be or may not be integrated with a cellular phone. The carrying case may also include attaching means as a belt clip.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

I claim:

1. A communication system comprising:
a) a primary electronic device having an integrated electro-mechanical interface; and
b) a secondary electronic device capable of being in electrical communication with said primary electronic device, the secondary electronic device having an electro-mechanical interface for physical and electronic mating with said integrated electro-mechanical interface of the primary electronic device in order to share resources between the primary and secondary electronic devices.

2. The communication system of claim 1 wherein said primary electronic device is a cellular telephone for use in a cellular telephone service provider's network.

3. The communicating system of claim 2 wherein said secondary electronic device is a wireless headset.

4. The communication system of claim 3 wherein said wireless headset uses Bluetooth technology to communicate electronically with said cellular telephone.

5. The communication system of claim 4 wherein on of said shared resources is a battery charging circuit.

6. The communication system of claim 4 wherein said cellular telephone further comprises an LCD display and one of said shared resources is to desplay the battery power level of LCD display.

7. The communication system of claim 5 further comprising a detachable LCD display and one of said shared resources is said detachable LCD display which can remain with said cellular phone or be detached in conjunction with said headset.

8. The communication system of claim 4 wherein said cellular telephone has a detachable speaker and a detachable microphone, and said shared resources includes said detachable speaker and said detachable microphone.

9. The communication system of claim 4 wherein said wireless headset further comprises means for releasably gripping the inner earlobe of a user.

10. The communication system of claim 9 wherein said gripping means comprises a plurality of flexible finger like projections.

11. The communication system of claim 4 wherein said integrated wireless headset, further comprises an earplug attachment means that pivots or snaps into the wireless headset when not in use.

12. The communication system of claim 1 wherein said primary electronic device is an audio playback device (e.g., an iPod, MP3, or similar device).

13. The communication system of claim 1 wherein said primary electronic device is a PDA.
